(19) United States
(12) Patent Application Publication
(10) Pub. No.: US 2005/0266851 A1
(43) Pub. Date: Dec. 1, 2005

(54) Wireless communication terminal, hand-off execution method, and hand-off execution program

(75) Inventor: Kenji Kouno, Kanagawa (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/142,015

(22) Filed: May 31, 2005

(30) Foreign Application Priority Data
May 31, 2004 (JP) P.2004-160799

(51) Int. Cl. H04Q 7/20

(52) U.S. Cl. 455/436

(57) ABSTRACT

A wireless communication terminal wirelessly communicates with a base station with employing a first communication method and a second communication method, in which an idle state in the second communication method is intermittently carried out under a communication state in the first communication method. The wireless communication terminal has a control unit which does not switch a base station in an idle state of the terminal to other base station until the wireless communication terminal fails to receive signals transmitted from the base station in an idle state of the terminal employing the second communication method at a predetermined number of times.

### CROSS-REFERENCE TO RELATED APPLICATIONS

This application is based upon and claims the benefit of priority from the prior Japanese Patent Applications No. 2004-160799, filed on May 31, 2004, the entire contents of which are incorporated herein by reference.

### BACKGROUND OF THE INVENTION

1. Field of the Invention

The present invention relates to a wireless communication terminal that performs communication by switching between two communication methods, while employing a common antenna, and a hand-off execution method and a hand-off execution program.

2. Description of the Related Art

A dual wireless communication terminal is known that can switch between two communication methods while communicating with a base station. In this specification, a dual wireless communication terminal, which can switch between two communication methods while employing a common antenna and which, although only one communication method is used when communicating, measures the wireless communication state of both communication methods, monitoring the arrival of calls, is specifically called a hybrid wireless communication terminal.

JP-A-2003-298762 is referred to as a related art.

With this hybrid wireless communication terminal, which mainly employs the CDMA2000 1x method for voice communication and which employs the 1xEV-DO method for dedicated data communication, each time a predetermined interval has expired (e.g., every 5.12 seconds), data communication using the 1xEV-DO method is suspended and the use of the antenna and the radio unit are switched to the CDMA2000 1x method, which monitors the arrival of calls, so that during data communication performed using the 1xEV-DO method the arrival of calls is monitored by the CDMA2000 1x method. Then, when the incoming call monitoring process has been terminated, use of the antenna and the radio unit is again switched to the 1xEV-DO method, and data communication is resumed.

When an area wherein the wireless communication terminal is present near the borders of the service areas of a plurality of base stations employed for the CDMA2000 1x method, i.e., when the qualities (e.g., RSSI values) of signals received from the base stations contend with each other, the CDMA2000 1x method may frequently repeat an idle hand-off (a hand-off performed in the idle state). In this situation, and in order to monitor incoming calls using the CDMA2000 1x method, the 1xEV-DO method is exchanged for the CDMA2000 1x method, repeatedly, at the predetermined interval described above, and the CDMA2000 1x method monitoring process is performed. At this time, when the idle hand-off of the CDMA2000 1x method is detected, and when the idle hand-off continues to be sequentially detected following the completion of the idle hand-off process, the occupation of the antenna and the radio unit of the wireless communication terminal by the CDMA2000 1x method is continued. And when this occupancy has continued for a predetermined period of time, the 1xEV-DO method determines whether a system lost has occurred, and initiates a data communication halt process.

That is, regardless of the radio transmission state of the 1xEV-DO method, the idle hand-off repeated by the CDMA2000 1x method causes data communication by the 1xEV-DO method to be disconnected.

### SUMMARY OF THE INVENTION

An object of the invention is to provide a wireless communication terminal, a hand-off execution method and a hand-off execution program, in which the wireless communication terminal switches between a first communication method and a second communication method to communicate with a base station, and prevents an unexpected disconnection of data communication while the communications employing the first communication method is performed even in a radio situation where an idle hand-off is frequently repeated under the second communication method.

The invention provides a wireless communication terminal wirelessly communicating with a base station with employing a first communication method and a second communication method, in which an idle state in the second communication method is intermittently carried out under a communication state in the first communication method, having: a control unit which does not switch a base station in an idle state of the terminal to other base station until the wireless communication terminal fails to receive signals transmitted from the base station in an idle state of the terminal employing the second communication method at a predetermined number of times.

The above “a control unit which does not switch a base station in an idle state of the terminal to other base station until the wireless communication terminal fails to receive signals transmitted from the base station in an idle state of the terminal employing the second communication method at a predetermined number of times” means “a control unit which switches a base station in an idle state of the terminal to other base station when the wireless communication terminal fails to receive signals transmitted from the base station in an idle state of the terminal employing the second communication method at a predetermined number of times.”

The wireless communication terminal further has: a movement detecting unit which detects a movement state of the wireless communication terminal, wherein the system control unit determines whether the wireless communication terminal moves based on a result obtained by the movement detecting unit, and when the system control unit determines that the wireless system terminal does not move, the control unit does not switch from the base station in an idle state of the terminal to other base station until the wireless communication terminal fails to receive signals transmitted from the base station in an idle state of the terminal employing the second communication method at a predetermined number of times.

The above “the control unit does not switch from the base station in an idle state of the terminal to other base station until the wireless communication terminal fails to receive signals transmitted from the base station in an idle state of the terminal employing the second communication method at a predetermined number of times” means “the control unit switches from the base station in an idle state of the terminal to other base station when the wireless communication terminal fails to receive signals transmitted from the base station in an idle state of the terminal employing the second communication method at a predetermined number of times.”

In the wireless communication terminal, the movement detecting unit employs a GPS to detect the movement state.

In the wireless communication terminal, the movement detecting unit obtains information related to an application under performance by the wireless communication terminal, and detects the movement state based on the obtained information related to the application.

The wireless communication terminal is designed to enable to be opened and closed, wherein the movement detecting unit detects the movement state based on a state where housings of the wireless communication terminal are opened or closed.

In wireless communication terminal, the first communication method is at least employed for data communications, and the second communication method is at least employed for voice communications.

In wireless communication terminal, the first communication method is CDMA2000 1xEV-DO method, and the second communication method is CDMA2000 1x method.

The invention also provides a hand-off execution program, causing a wireless communication terminal wirelessly communicating with a base station with employing a first communication method and a second communication method, in which an idle state in the second communication method is intermittently carried out under a communication state in the first communication method, to perform a hand-off operation of a base station in an idle state of the terminal employing the second communication method, including: a first second step of determining whether the wireless communication terminal fails to receive signals transmitted from the base station in an idle state of the terminal employing the second communication method at a predetermined number of times; and a second step of, when the wireless communication terminal fails to receive signals transmitted from the base station in an idle state of the terminal employing the second communication method at the predetermined number of times, switching from the base station in an idle state of the terminal to other base station.

The hand-off execution program further includes: a third step of detecting a movement state of the wireless communication terminal and of determining whether the wireless communication terminal moves, wherein the first and the second steps are performed only when it is determined that the wireless communication terminal does not move.

In the hand-off execution program, at the third step, a GPS is employed to detect the movement state of the wireless communication terminal.

In the hand-off execution program, at the third step, information related to an application under performance by the wireless communication terminal is obtained, and the movement state of the wireless communication terminal is detected based on the obtained information related to the application.

In the hand-off execution program, the wireless communication terminal is designed to enable to be opened and closed, and at the third step, the movement state of the wireless communication terminal is detected based on a state where housings of the wireless communication terminal are opened or closed.

The invention also provides a hand-off execution method of a wireless communication terminal wirelessly communicating with a base station with employing a first communication method and a second communication method, in which an idle in the second communication method is intermittently carried out under a communication state in the first communication method, and which performs a hand-off operation of a base station in an idle state of the terminal employing the second communication method, including: a first step of determining whether the wireless communication terminal fails to receive signals transmitted from the base station in an idle state of the terminal employing the second communication method at a predetermined number of times; and a second step of, when the wireless communication terminal fails to receive signals transmitted from the base station in an idle state of the terminal employing the second communication method at the predetermined number of times, switching from the base station in an idle state of the terminal to other base station.

The hand-off execution method further includes: a third step of detecting a movement state of the wireless communication terminal and of determining whether the wireless communication terminal moves, wherein the first and the second steps are performed only when it is determined that the wireless communication terminal does not move.

In the hand-off execution method, at the third step, a GPS is employed to detect the movement state of the wireless communication terminal.

In the hand-off execution method, at the third step, information related to an application under performance by the wireless communication terminal is obtained, and the movement state of the wireless communication terminal is detected based on the obtained information related to the application.

In the hand-off execution method, the wireless communication terminal is designed to enable to be opened and closed, and at the third step, the movement state of the wireless communication terminal is detected based on a state where the housings of wireless communication terminal are opened or closed.

The invention also provides a wireless communication terminal wirelessly communicating with a base station with employing a first communication method and a second communication method, and enables to be in an idle state employing the first communication method and the second communication method, having: a control unit which, when a difference between quality of signals transmitted from a base station in an idle state of the terminal and quality of signals transmitted from another base station exceeds a predetermined threshold value, switches a base station for the idle state to the other base station from the base station in an idle state of the terminal; and a movement detecting unit which detects a movement state of the wireless communication terminal, wherein the control unit determines whether the wireless communication terminal is in communication employing the first communication method, and the control unit varies the predetermined threshold value based on a result obtained by the movement detecting unit when the wireless communication terminal is in communication employing the first communication method.

According to the wireless communication terminal, the hand-off execution method and the hand-off execution program, the frequency of the occurrence of the hand-off under the second communication method can be reduced while the communication employing the first communication method is performed. Therefore, the unexpected data communication disconnections during communications employing the first communication method seldom occur. As a result, stable data communications can be provided, and the throughput of data communications can be improved.

### BRIEF DESCRIPTION OF THE DRAWINGS

FIG. 1 is a block diagram showing the configuration of a wireless communication terminal 200 according to an embodiment of the present invention;

FIG. 2 is a diagram for explaining the state of an RF controller 40 in the standby state;

FIG. 3 is a diagram for explaining the state of the RF controller 40 when a hand-off occurs in the CDMA2000 1x method;

FIG. 4 is a diagram for explaining the state of the RF controller 40 when the 1x method is performing a standby process while the 1xEV-DO method is performing communication;

FIG. 5 is a diagram for explaining the state of the RF controller 40 when a hand-off occurs in the CDMA2000 1x method while the 1xEV-DO method is performing communication;

FIG. 6 is a flowchart showing a hand-off process;

FIG. 7 is a flowchart showing a normal mode hand-off process;

FIG. 8 is a flowchart showing a moving mode hand-off process; and

FIG. 9 is a flowchart showing a stationary mode hand-off process.

### DETAILED DESCRIPTION OF THE PREFERRED EMBODIMENTS

An embodiment of the present invention will now be described while referring to the drawings.

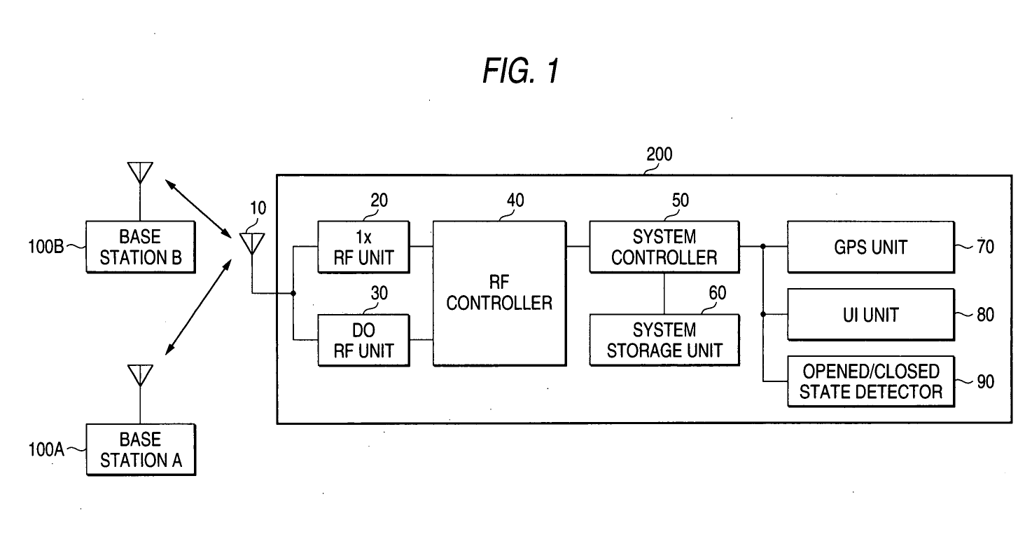

FIG. 1 is a block diagram showing the configuration of a wireless communication terminal according to an embodiment of the invention.

A wireless communication terminal (cellular phone terminal) 200 according to the embodiment can switch between the CDMA2000 1x communication method (hereinafter referred to as the “1x method”) and the 1xEV-DO communication method (hereinafter referred to as the “DO method”) while using a common antenna 10, and through the performance of a hand-off operation, can enable communication, while moving, between a base station 100A and a base station 100B.

Via the antenna 10, a high frequency signal received from a 1x RF unit 20 or a DO RF unit 30 is converted into an electric wave and transmitted to the base station 100A or 100B, or an electric wave received from the base station 100A or 100B is converted into a high frequency signal and transmitted to the 1x RF unit 20 or the DO RF unit 30.

The 1x RF unit 20 converts into a high frequency signal a data signal or an audio signal to be transmitted using the 1x method, and transmits the high frequency signal to the antenna 10. The 1x RF unit 20 also converts a high frequency signal received via the antenna 10 into a data signal or an audio signal.

The DO RF unit 30 converts into a high frequency signal a data signal to be transmitted using the DO method, and transmits the high frequency signal to the antenna 10. The DO RF unit 30 also converts a high frequency signal received via the antenna 10 into a data signal.

An RF controller 40 controls the communications performed using the two methods, the DO method and the 1x method, and also measures the pilot signal strength (RSSI) transmitted by the base station 100 to the antenna 10.

A system controller (system control unit) 50 controls in their entirety the individual sections of the wireless communication terminal 200. The system controller 50 controls the RF controller 40, and switches between the DO method and the 1x method. And especially in the idle state, the system controller 50 selectively exchanges these two communication methods, at a predetermined time interval, while awaiting the arrival of a call using either communication method. Further, based on the pilot signal strength transmitted by a base station to the antenna 10 in the idle state, during which the arrival of a call is awaited while using the 1x method, the system controller 50 determines whether a hand-off operation should be performed. Then, when the system controller 50 determines that a hand-off is necessary, the system controller 50 performs the hand-off process. It should be noted that in this specification the operation for switching the other base station that is connected is called a hand-off operation. The system controller 50 also employs position information obtained by a GPS (Global Positioning System) unit 70 to determine whether the wireless communication terminal 200 is currently moving.

A system storage unit 60 is constituted by a memory such as a RAM, and is used to store an application and temporary data.

The GPS (Global Positioning System) unit 70 receives GPS signals from a plurality of GPS satellites, and employs the difference in the time whereat these signals are received to perform measurements to determine the location of the wireless communication terminal 200.

A UI unit 80 serves as an interface for a user who is operating the wireless communication terminal 200, and includes an LCD display panel (a main display panel and a sub-display panel) for displaying characters and images, a loudspeaker for outputting sounds, a microphone for the input of sounds, and input keys for accepting entries by a user.

An opened/closed state detector 90 detects the state wherein the wireless communication terminal 200 is open or closed. And in the embodiment, the wireless communication terminal 200 is a so-called folder type wherein two housings are coupled together so that both are either open or closed. When the wireless communication terminal 200 is open, data can be identified on the display panel of the housing, and voice communication can be performed by using the microphone and the loudspeaker provided for the housing. When the wireless communication terminal 200 is closed, by closing the housing, the display panel, the microphone and the loudspeaker are hidden, so that the display panel can not be seen and the voice communication can not be performed. The opened/closed state detector 90 detects the state of a housing (open or closed), and transmits the detection results to the system controller 50.

Instead of the opening or closing of the housing, the opened/closed state detector 90 may detect whether the antenna 10 is extended or retracted.

The operation of the wireless communication terminal of the embodiment will now be described.

According to the wireless communication terminal 200 of the embodiment, the RF controller 40 is used in common by the 1x method and the DO method, and either of the methods that performs communication can occupy the RF controller 40.

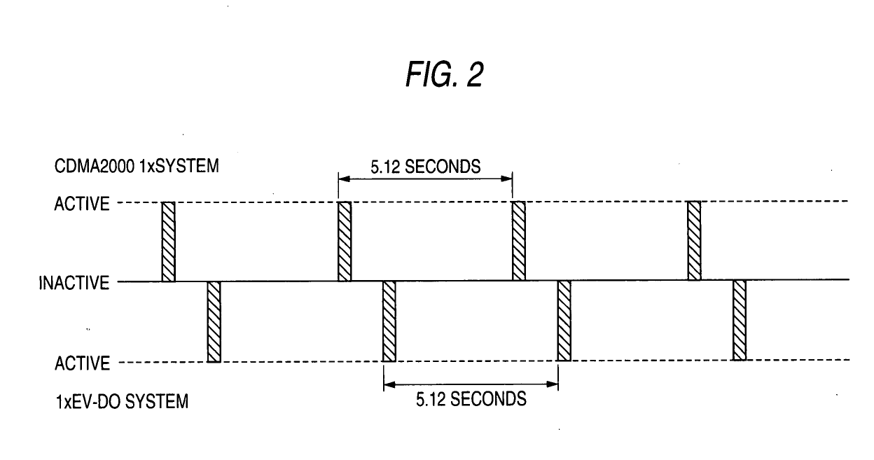

FIG. 2 is a diagram for explaining the state of the RF controller 40 in the idle state of the wireless communication terminal 200.

At each expiration of a predetermined time period (5.12 seconds in the embodiment), the 1x method and the DO method perform the idle state process for detecting a pilot signal indicating the arrival of a call, and the operating state of the RF controller 40 for the individual methods becomes “Active”. Since the RF controller 40 is occupied by one of the methods that performs the idle state process, between these two methods, the times at which the idle state is effective differ.

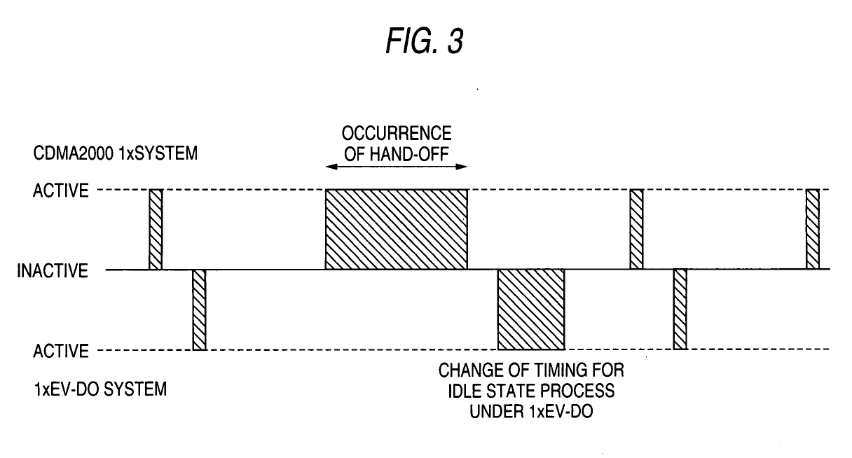

FIG. 3 is a diagram for explaining the state of the RF unit 40 when a hand-off (idle hand-off) occurs in the 1x method while the idle state process is being performed.

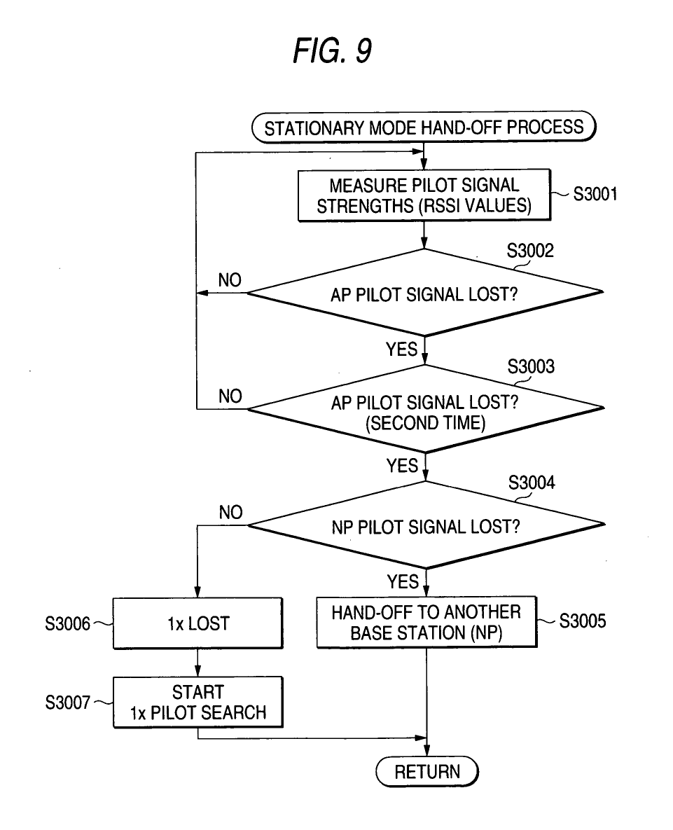

The wireless communication terminal 200 compares the pilot signal strength of a specific base station that is currently communicating and the pilot signal strength that is the best of all the other base stations, and performs the hand-off process for the specific base station when the difference in the pilot signal strength of the two base stations exceeds a predetermined threshold value. The hand-off process (a normal mode hand-off process) will be described later while referring to FIG. 9.

In the example in FIG. 3, the hand-off process is performed by the 1x method while both the 1x method and the DO method are performing the idle state process. Since the timing for the performance of the idle state process differs for each base station, when a communication destination is switched to a different base station by the performance of the hand-off process, the timing for the idle state process is changed. As the timing at which the 1x method performs the idle state process is changed, the DO method also changes the timing for the idle state process to avoid the overlapping of the idle state process timing for the 1x method. The change for this timing is effected by the exchange of a predetermined message by the wireless communication terminal 200 and the base station.

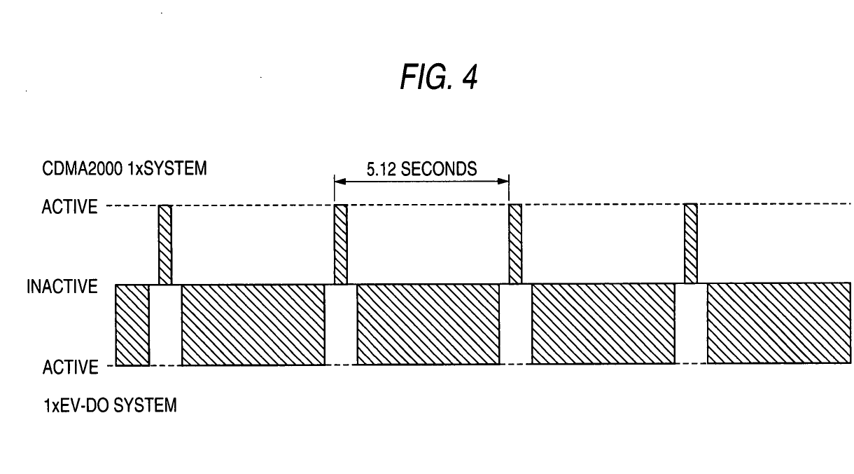

FIG. 4 is a diagram for explaining the state of the RF controller 40 when the 1x method performs the idle state process while the DO method is being used for communication.

When the time to perform the idle state process using the 1x method is reached while communication (data communication) using the DO method is being performed, the method used by the RF controller 40 is switched to the 1x method. Then, when the idle state process has been completed, the method used by the RF controller 40 is again switched to the DO method.

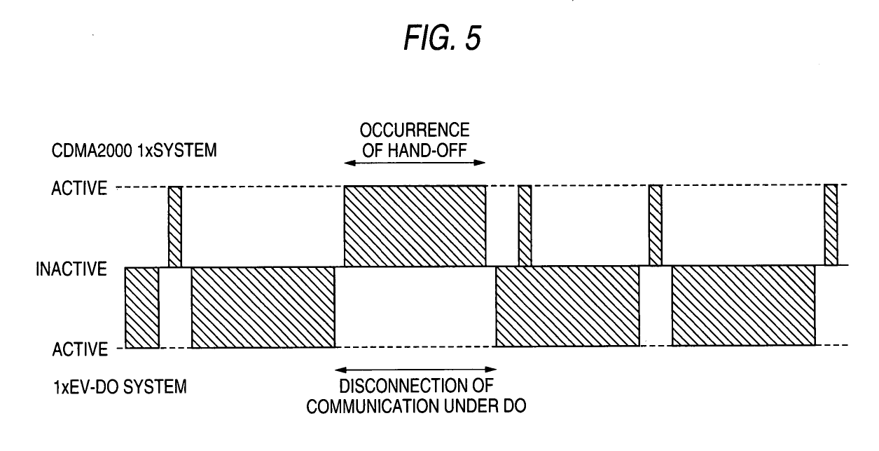

FIG. 5 is a diagram for explaining the state of the RF controller 40 wherein, during the performance of communication by the DO method, the hand-off occurs in the 1x method, which is currently performing the idle state process.

As explained while referring to FIG. 4, the 1x method performs the idle state process at a predetermined time interval, while the DO method is performing communication. When the occurrence of a hand-off in the 1x method is detected during the idle state process, the RF controller 40 and the base station 100 perform the hand-off process. During the hand-off process, the RF controller 40 is operated exclusively by the 1x method. Then, when the hand-off process has been completed, control of the RF controller 40 reverts to the DO method, and communication is resumed.

When immediately following the detection of the occurrence of a hand-off in the 1x method a succeeding hand-off is sequentially detected, operation of the RF controller 40 of the wireless communication terminal by the 1x method is continued and communications performed by the DO method can not be resumed until the hand-off process is completed. Since the DO method is so designed that data communications are disconnected when interrupted for a predetermined period of time, when operation of the RF controller 40 by the 1x method is continued, because a hand-off process is being performed, and a predetermined period of time has elapsed since communications performed by the DO method was interrupted, data communications are disconnected by the DO.

Therefore, as will be described below, the wireless communication terminal 200 of the embodiment determines whether communication is currently being performed by the DO method, and when data communication is currently being performed, it reduces the frequency at which hand-offs occur in the 1x method. Further, whether the wireless communication terminal 200 is currently moving is determined, and when the wireless communication terminal 200 is not being moved, but is stationary, the frequency at which hand-offs occur in the 1x method is reduced to the minimum, as necessary.

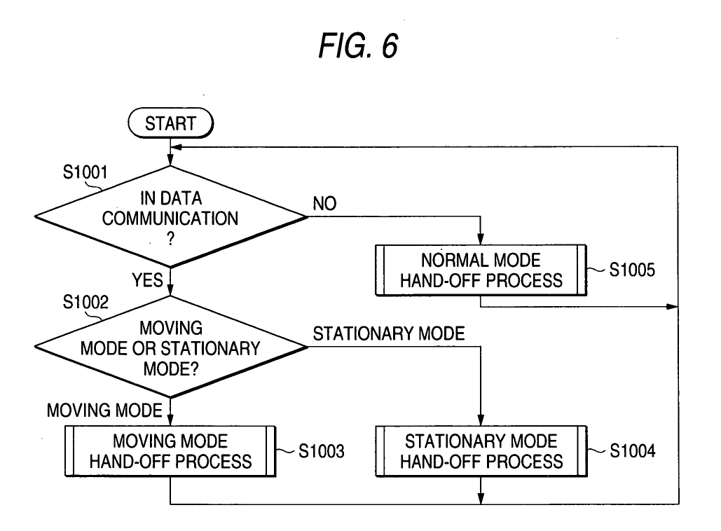

FIG. 6 is a flowchart showing the hand-off process performed by the system controller 50.

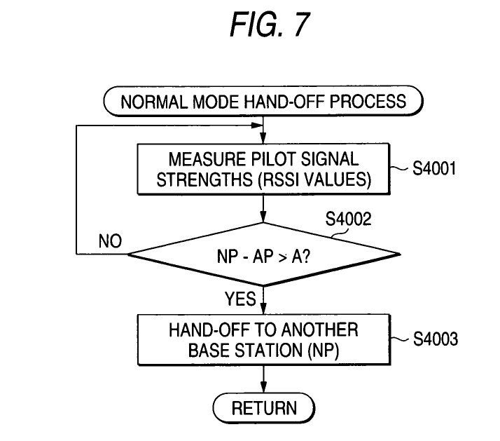

First, the system controller 50 determines whether data communication is currently being performed by the DO method (step 1001). When the system controller 50 determines that data communication is not being performed by the DO method, a normal mode hand-off process is performed by the system controller 50 (FIG. 7). On the other hand, when the system controller determines that data communication is currently being performed by the DO method, the system controller 50 determines whether the current mode is a “moving mode” or a “stationary mode” (step 1002).

When the wireless communication terminal 200 is currently being moved, the system controller 50 determines that the operating mode is the “moving mode”. Whereas when the wireless communication terminal 200 is not being moved (or the range of movement or the speed of movement is extremely small), the system controller 50 determines the operating mode is the “stationary mode”.

For the determination of the operating mode, the system controller 50 employs the current location of the wireless communication terminal 200 that is obtained by the PS unit 70 over a predetermined period of time. Thus, when the distance moved during this period exceeds a predetermined distance, e.g., the distance moved in ten minutes exceeds 100 m, the system controller 50 determines that the operating mode is the moving mode, while in other cases, it determines that the operating mode is the stationary mode.

The system controller 50 may employ the state of the housings detected by the opened/closed state detector 90 to determine the operating mode. For example, when the wireless communication terminal 200 is stably positioned, to watch a streaming picture, the user may open the housings to view the data presented on the main display panel. Or, when the wireless communication terminal 200 is to be moved while downloading data, the user may close the housings and carry the wireless communication terminal 200 in his or her pocket or bag. In this case, during data communication performed using the DO method, when the housings are opened, the system controller 50 may identify the operating mode as the “stationary mode”, or when the housings are opened, as the “moving mode”.

Furthermore, the opened/closed state detector 90 may also detect the state wherein the antenna is extended or retracted. When the antenna is extended, it can be determined that a streaming picture is probably being watched while the wireless communication terminal 200 is stably positioned. Whereas when the antenna is retracted, it can be determined it is highly probable the wireless communication terminal 200 is being carried in a pocket or a bag of a user and is being moved. Therefore, in the extended state of the antenna 10, it can be determined that the operating mode is the “stationary mode”, or in the retracted state, it can be determined that the operating mode is the “moving mode”.

There is one more determination example of the opened/closed state detector 90 is used. As previously described, the wireless communication terminal 200 of the embodiment enables voice communication (voice communication using the 1x method) only when the housings are opened, and disables voice communication when the housings are closed. Therefore, when the housings are closed during data communication performed using the DO method, it may be determined that the preference of the use of the 1x method is low because voice communication is disabled and that the operating mode is the “stationary” mode, in order to reduce the frequency at which hand-offs occur. The same procedure as is employed for the opened/closed state detector 90 is employed when the state of the antenna is being detected. That is, when the antenna is extended, it can be determined that the probability is high that voice communication is being performed, while when the antenna is retracted, it can be determined that the probability is low that voice communication is being performed. As a result, in the extended state of the antenna, the operating mode can be determined to be the “moving mode”, and in the retracted state of the antenna, the operating mode can be determined to be the “stationary mode”. Further, the system controller 50 may employ an application currently operated by the wireless communication terminal 200 in order to identify the “moving mode” or the “stationary mode”. Specifically, when an application is being employed that is mainly used while the wireless communication terminal 200 is moving, the operating mode is determined to be the “moving mode”. Whereas when an application is being employed that is mainly used while the wireless communication terminal 200 is stably positioned, the operating mode is determined to be the “stationary mode”. An example application used while the wireless communication terminal 200 is moving is “map display application”, and an example application used while the wireless communication terminal 200 is stably positioned is “media player”, for receiving and browsing a stream picture.

As is described above, the GPS unit 70, the opened/closed state detector 90 and the system controller 50 constitute a movement detecting unit for detecting the operating state of the wireless communication terminal 200.

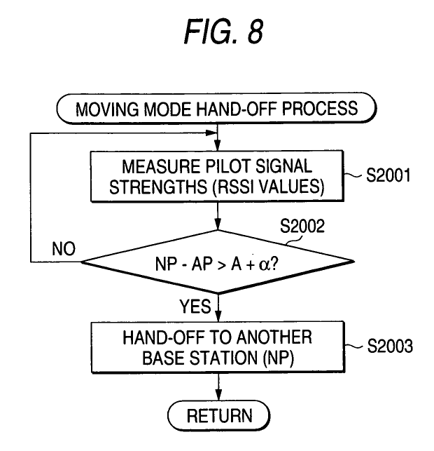

When the system controller 50 determines at step 1002 that the operating mode is the “moving mode”, the system controller 50 shifts to a moving mode hand-off process (step 1003 in FIG. 8), or when the system controller 50 determines the operating mode is the “stationary mode”, the system controller 50 shifts to a stationary mode hand-off process (step 1004 in FIG. 9).

Since it is highly probable in the “moving mode” that hand-offs will occur in the 1x method, the frequency at which hand-offs occur is reduced to avoid data communication disconnections by the DO method. Since the wireless communication terminal 200 is not moved in the “stationary mode” (or the housings are closed and the preference for the performance of voice communication is low), the occurrence of hand-offs is prevented as much as possible.

FIG. 7 is a flowchart showing a normal hand-off process performed by the system controller 50.

The “normal mode” applies to a process performed when communication is not performed by the DO method.

First, the system controller 50 obtains pilot signal strength (RSSI values) from base stations (step 4001). It is here assumed that the pilot signal strength of a base station with which communication is currently being performed is “AP”, and that for all the other base stations the highest pilot signal strength is “NP”.

Then, the system controller 50 determines whether a difference between the two pilot signal strengths that are obtained exceeds a predetermined threshold value (step 4002). Specifically, the system controller 50 determines whether a value obtained by subtracting the pilot signal strength AP, for the current base station, from the pilot signal strength NP, for the other base station, exceeds a threshold value “A”, which is defined in advance for hand-off determination.

When the system controller 50 determines that the difference between the two pilot signal strengths does not exceed the predetermined threshold value, the system controller 50 returns to step 4001 and repeats the same process. However, when the system controller 50 determines that the difference between the two pilot signal strengths exceeds the threshold value, the system controller 50 performs a hand-off process to switch from the current base station to the other base station (step 4003).

FIG. 8 is a flowchart showing the “moving mode” hand-off process performed by the system controller 50.

First, the system controller 50 obtains pilot signal strengths (RSSI values) from base stations (step 2001). It is here assumed that the pilot signal strength of a base station with which communication is currently being performed is “AP”, and that for all the other base stations the highest pilot signal strength is “NP”.

Then, the system controller 50 determines whether a difference between the two obtained pilot signal strengths exceeds a threshold value (A+α) (step 2002). Specifically, the system controller 50 determines whether a value obtained by subtracting the pilot signal strength “AP”, for the current base station, from the pilot signal strength “NP”, for the other base station, exceeds a value obtained by adding a predetermined value “α” to the threshold value “A”, and uses the obtained value to determine whether a hand-off is to be performed in the normal mode.

When the system controller 50 determines that the difference between the two pilot signal strengths does not exceed the predetermined threshold value, the system controller 50 returns to step 2001 and repeats the same process. However, when the system controller 50 determines that the difference between the two pilot signal strengths exceeds the threshold value, the system controller 50 performs the hand-off process by switching from the current base station to the other base station (step 2003). That is, the threshold value for determining the hand-off is increased and exceeds that in the normal mode, and the frequency at which hand-offs occur is reduced.

In the processing shown in FIG. 8, since during data communication using the DO method the threshold value for the pilot signal strength, which is used by the wireless communication terminal 200 to perform a hand-off, is increased so that it is higher than in the normal state, the frequency at which hand-offs occur can be reduced. Thus, during data communication using the DO method, the data communication disconnections, due to the occurrence of hand-offs in the 1x method, can be prevented.

FIG. 9 is a flowchart showing the stationary mode hand-off process performed by the system controller 50.

First, the system controller 50 obtains pilot signal strengths (RSSI values) from base stations (step 3001). Here it is assumed that the pilot signal strength of a base station with which communication is currently being performed is “AP”, and that for all the other base stations the highest pilot signal strength is “NP”.

Then, the system controller 50 determines whether reception of a signal from the current base station at the pilot signal strength “AP” has been disabled, i.e., whether currently, an AP signal has been lost (step 3002). When the system controller 50 determines that the AP signal has not been lost, the system controller 50 returns to step 3001 and repeats the same process. When the system controller 50 determines that the AP signal has been lost, the system controller 50 obtains, following the elapse of the next time period (5.12 seconds later in the embodiment), the pilot signal strength (AP) of the current base station, and determines whether the obtained AP has been lost (step 3003). When the system controller 50 determines that the obtained AP has not been lost, the system controller 50 returns to step 3001 and repeats the same process. When the system controller 50 determines that the obtained AP has been lost, i.e., determines two consecutive times that the pilot signal strength of the current base station has been lost, the system controller 50 determines whether the pilot signal strength (NP) of a different base station, not the current base station, has been lost. When the system controller 50 determines that the NP has not been lost, the system controller 50 switches from the current base station to the different base station (step 3005). The system controller 50 thereafter returns to the processing performed according to the flowchart in FIG. 6.

When the system controller 50 determines at step 3004 that the NP has been lost, the system controller 50 assumes that the communication using the 1x method has been lost (communication with the current base station has been disconnected), because the current base station (AP) and the other base station (NP) have both been lost (step 3006). Thereafter, the system controller 50 searches for a pilot signal in order to initiate communication with another base station (step 3007).

According to the processing in FIG. 9, since communication is switched from the current base station to another base station by a hand-off process only when it is determined two consecutive times that communication with the current base station has been lost, the frequency at which hand-offs occur can be reduced as much as possible. Therefore, during data communication using the DO method, disconnection of the data connection due to the occurrence of a hand-off in the 1x method can be prevented.

As is described above, according to the wireless communication terminal 200 of the embodiment, which is a hybrid terminal that employs both the CDMA2000 1x method and the 1xEV-DO method, the frequency at which hand-offs occur in the CDMA2000 1x method can be reduced as much as possible during data communication performed using the 1xEV-DO method. With this arrangement, when the wireless communication terminal 200 is located near the border of the service areas for a plurality of base stations (the signal strengths (RSSI values) of the base stations contend with each other), and when a hand-off process that uses the CDMA2000 1x method is frequently performed, the unexpected disconnection of data communications under the 1xEV-DO method can be prevented. As a result, stable data communication can be performed, and the throughput of the data communication can be increased.

According to the embodiment, pilot signal strength (an RSSI value) has been employed to determine whether a hand-off process should be performed. However, a carrier-to-interference ratio (a C/I value) for pilot signals may also be employed.

Furthermore, in the embodiment, the hybrid wireless communication terminal employing the CDMA2000 1x method and the 1xEV-DO method has been explained. However, other communication terminal types can be used so long as they, can employ two communication methods, while using a common antenna, and can switch between these communication methods, so that the wireless communication state of one communication method can be measured while communication is being performed using the other communication method and the arrival of calls can be monitored.

Further, in the embodiment, a stationary mode hand-off process has been explained wherein a hand-off is performed when the acquisition of a pilot signal transmitted by a base station has failed two consecutive times. However, the number of failures is not limited to two, and the number of failures, such as three, four or even one, may be designated in advance. In addition, the hand-off process may not only be performed when the acquisition of a pilot signal transmitted by the base station has failed sequentially a predetermined number of times, but also when the acquisition of a pilot signal has intermittently failed a predetermined number of times during a specific time period.

Moreover, according to the embodiment, the GPS unit 70 receives GPS signal from a plurality of GPS satellites, and to obtain the location of the wireless communication terminal 200, performs measurements based on the differences in times whereat these signals were received. However, since calculations employing arithmetic are required to perform measurements to obtain the actual location, and since the processing load imposed on the GPS unit 70 is thereby increased, the GPS unit 70 may transmit, to the base station 100, information concerning the differences in times whereat the signals were received from the GPS satellites, and the base station 100 may perform the calculations, based on the received information, to obtain the location of the wireless communication terminal 200, which it then transmits to the wireless communication terminal 200.

Further, in the embodiment, a so-called folder type wireless communication terminal, wherein two housings are coupled together so that both are either open or closed, has been explained; however, the structure is not limited to this so long as a wireless communication terminal can be opened and closed. The wireless communication terminal may, for example, be a flip type, wherein a protective member, connected to a housing, covers only the part of the housing that is to be opened or closed; a horizontal pivot type, wherein two housings are so coupled they can each be horizontally pivoted; or a slide type, wherein two housings slide vertically across each other when they are opened or closed.

1. A wireless communication terminal wirelessly communicating with a base station with employing a first communication method and a second communication method, in which an idle state in the second communication method is intermittently carried out under a communication state in the first communication method, comprising:
a control unit which does not switch a base station in an idle state of the terminal to other base station until the wireless communication terminal fails to receive signals transmitted from the base station in an idle state of the terminal employing the second communication method at a predetermined number of times.

2. The wireless communication terminal according to claim 1, further comprising:
a movement detecting unit which detects a movement state of the wireless communication terminal,
wherein the system control unit determines whether the wireless communication terminal moves based on a result obtained by the movement detecting unit, and
when the system control unit determines that the wireless system terminal does not move, the control unit does not switch from the base station in an idle state of the terminal to other base station until the wireless communication terminal fails to receive signals transmitted from the base station in an idle state of the terminal employing the second communication method at a predetermined number of times.

3. The wireless communication terminal according to claim 2,
wherein the movement detecting unit employs a GPS to detect the movement state.

4. The wireless communication terminal according to claim 2,
wherein the movement detecting unit obtains information related to an application under performance by the wireless communication terminal, and detects the movement state based on the obtained information related to the application.

5. The wireless communication terminal according to claim 2, which is designed to enable to be opened and closed,
wherein the movement detecting unit detects the movement state based on a state where housings of the wireless communication terminal are opened or closed.

6. The wireless communication terminal according to claim 1,
wherein the first communication method is at least employed for data communications, and the second communication method is at least employed for voice communications.

7. The wireless communication terminal according to claim 1,
wherein the first communication method is CDMA2000 1xEV-DO method, and the second communication method is CDMA2000 1x method.

8. A hand-off execution program, causing a wireless communication terminal wirelessly communicating with a base station with employing a first communication method and a second communication method, in which an idle state in the second communication method is intermittently carried out under a communication state in the first communication method, to perform a hand-off operation of a base station in an idle state of the terminal employing the second communication method, comprising:
a first step of determining whether the wireless communication terminal fails to receive signals transmitted from the base station in an idle state of the terminal employing the second communication method at a predetermined number of times; and
a second step of, when the wireless communication terminal fails to receive signals transmitted from the base station in an idle state of the terminal employing the second communication method at the predetermined number of times, switching from the base station in an idle state of the terminal to other base station.

9. The hand-off execution program according to claim 8, further comprising:
a third step of detecting a movement state of the wireless communication terminal and of determining whether the wireless communication terminal moves,
wherein the first and the second steps are performed only when it is determined that the wireless communication terminal does not move.

10. The hand-off execution program according to claim 9,
wherein, at the third step, a GPS is employed to detect the movement state of the wireless communication terminal.

11. The hand-off execution program according to claim 9,
wherein, at the third step, information related to an application under performance by the wireless communication terminal is obtained, and the movement state of the wireless communication terminal is detected based on the obtained information related to the application.

12. The hand-off execution program according to claim 9,
wherein the wireless communication terminal is designed to enable to be opened and closed, and
at the third step, the movement state of the wireless communication terminal is detected based on a state where housings of the wireless communication terminal are opened or closed.

13. A hand-off execution method of a wireless communication terminal wirelessly communicating with a base station with employing a first communication method and a second communication method, in which an idle state in the second communication method is intermittently carried out under a communication state in the first communication method, and which performs a hand-off operation of a base station in an idle state of the terminal employing the second communication method, comprising:
a first step of determining whether the wireless communication terminal fails to receive signals transmitted from the base station in an idle state of the terminal employing the second communication method at a predetermined number of times; and
a second step of, when the wireless communication terminal fails to receive signals transmitted from the base station in an idle state of the terminal employing the second communication method at the predetermined number of times, switching from the base station in an idle state of the terminal to other base station.

14. The hand-off execution method according to claim 13, further comprising:
a third step of detecting a movement state of the wireless communication terminal and of determining whether the wireless communication terminal moves,
wherein the first and the second steps are performed only when it is determined that the wireless communication terminal does not move.

15. The hand-off execution method according to claim 14,
wherein, at the third step, a GPS is employed to detect the movement state of the wireless communication terminal.

16. The hand-off execution method according to claim 14,
wherein, at the third step, information related to an application under performance by the wireless communication terminal is obtained, and the movement state of the wireless communication terminal is detected based on the obtained information related to the application.

17. The hand-off execution method according to claim 14,
wherein the wireless communication terminal is designed to enable to be opened and closed, and
at the third step, the movement state of the wireless communication terminal is detected based on a state where the housings of wireless communication terminal are opened or closed.

18. A wireless communication terminal wirelessly communicating with a base station with employing a first communication method and a second communication method and enables to be in an idle state employing the first communication method and the second communication method, comprising:
a control unit which, when a difference between quality of signals transmitted from a base station in an idle state of the terminal and quality of signals transmitted from another base station exceeds a predetermined threshold value, switches a base station for the idle state to the other base station from the base station in an idle state of the terminal; and
a movement detecting unit which detects a movement state of the wireless communication terminal,
wherein the control unit determines whether the wireless communication terminal is in communication employing the first communication method, and the control unit varies the predetermined threshold value based on a result obtained by the movement detecting unit when the wireless communication terminal is in communication employing the first communication method.
